(19) United States
(12) Patent Application Publication
(10) Pub. No.: US 2011/0285480 A1
(43) Pub. Date: Nov. 24, 2011

(54) EQUALIZER WITH A VARIABLE TRANSFER CURVE

(75) Inventors: Giusepe Pinto, Roma (IT); Marco Bartocci, Roma (IT); Federico Fazi, Roma (IT); Antonio Tafuto, Roma (IT); Egidio Ciacia, Roma (IT)

(73) Assignee: ELECTTRONICA S.P.A, Roma (IT)

(21) Appl. No.: 13/146,056

(22) PCT Filed: Jan. 15, 2010
(86) PCT No.: PCT/IT2010/000008

§ 371 Date: Jul. 25, 2011

(30) Foreign Application Priority Data
Jan. 23, 2009 (IT) RM2009A000022

(51) Int. Cl. H04B 3/14

(52) U.S. Cl. 333/28 R

(57) ABSTRACT

Microwave signal equalizer comprising a signal transmission line, a first open stub and a second open stub which are applied in parallel to the said transmission line by a respective connection circuit, said first open stub and second open stub being controlled by at least one second dc control voltage which is applied to the respective connection circuit, said second control voltage being variable and said connection circuit being able to produce a variable resistance upon variation of said second control voltage.

The present invention relates to a microwave signal equalizer with an attenuation curve which can be varied by means of electric commands.

It is known, in the radio communications sector, that microwave receivers, which must operate within a wide frequency band, require filtering structures with high selectivity and equalization characteristics in order to obtain signals with a constant amplitude and phase when there is a variation in frequency, while at the same time ensuring the sensitivity and linearity required for correct operation thereof.

An example of this need exists, for example, in the case of superheterodyne receivers which are used to perform a required frequency conversion since subsequent processing of the signal may occur correctly only for signals which are included within a frequency band (so-called intermediate frequency) which is lower than the original frequency captured by the antenna.

Since in the case of wide-band receivers, the amplitude of the incoming/outgoing transfer function gradually diminishes with an increase in the frequency, producing a corresponding distortion which increases with the frequency itself, the specific task of equalizers is to introduce, into the reception chain, compensation of the receiver transfer curve which is opposite (positive) compared to that of the receiver so that, when added thereto, it produces a resultant transfer curve which remains sufficiently flat upon variation in frequency within the working band.

Also known are equalizers which are able to be used for this purpose in wide-band receivers; these equalizers, however, have structural drawbacks in that the manufacturing tolerances and the tolerances of the individual components forming said equalizers result in a transfer function which varies from one equalizer to another.

Consequently, in order to obtain the desired transfer functions, a great deal of calibration of all the components is necessary in order to compensate for the effects due to the said intrinsic tolerances of the components and this particularly in those cases, such as military applications, where a high calibration and operating precision are required.

In addition, calibration of the equalizer must be performed depending on the specific receiver with which it is associated, taking into account the fact that each receiver in turn has a transfer function which is not precisely defined.

The calibration and testing activity is even more critical owing to the variability in the transfer function of the equalizers and the associated components within a wide temperature range, as for example required in the said military applications, where the equalizers must operate at temperatures ranging from −40 to +70° C.

It is also known that said calibration operations are currently performed manually, using materials which have a high dielectric constant, gold foil, absorbent materials and the like, so as to offset, by inductive, capacitive or resistive means, the undesired effects which are due to the tolerance of the receivers components with a concentrated or distributed constant.

Calibration is therefore particularly critical since, owing to the fact that the signal equalizers have a fixed transfer function, said equalizers must be calibrated individually and/or manually interchanged, selecting different equalizers from among those with different values until the combination which satisfies the system requirements is found.

In connection with the above, the production of the known equalizers and microwave receivers gives rise to a series of drawbacks, including:
lengthy nature of the calibration and testing operations which account for about 40% of the labour time needed to produce an equalizer;
high frequency of human error and dependency of calibration quality on the capacity of the individual operator;
poor repeatability of the equalizer operating characteristics with a consequent high percentage of production rejects.

The technical problem which is posed, therefore, is to provide an equalizer, particularly, but not exclusively, for wide-band microwave receivers, which may be produced and calibrated reliably and rapidly, solving said problems associated with the known calibration procedures.

In connection with this technical problem it is also required that the device should have electrical characteristics which may be modified in a dynamic and reversible manner so that they may remain constant in relation to the variations in the operating temperature range.

These results are achieved according to the present invention by an equalizer with a variable transfer curve according to the characteristic features of Claim 1.

Further details may be obtained from the following description of a non-limiting example of embodiment of the subject of the present invention provided with reference to the accompanying drawings in which:

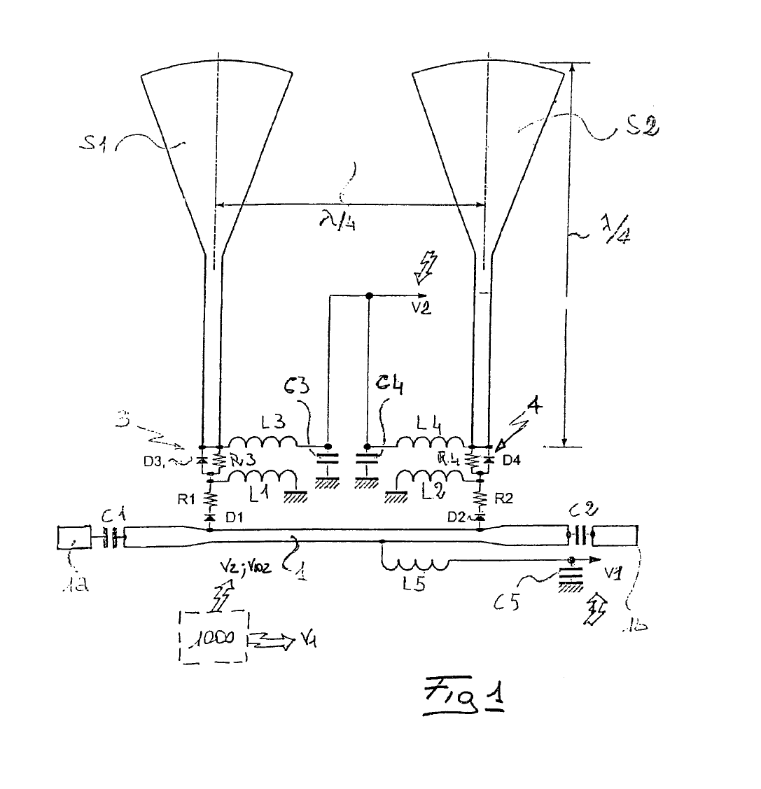

FIG. 1 shows a circuit diagram of a first embodiment of a variable equalizer according to the present invention;

FIG. 2 shows the diagram of the equivalent circuit of the equalizer according to FIG. 1 corresponding to a first control condition;

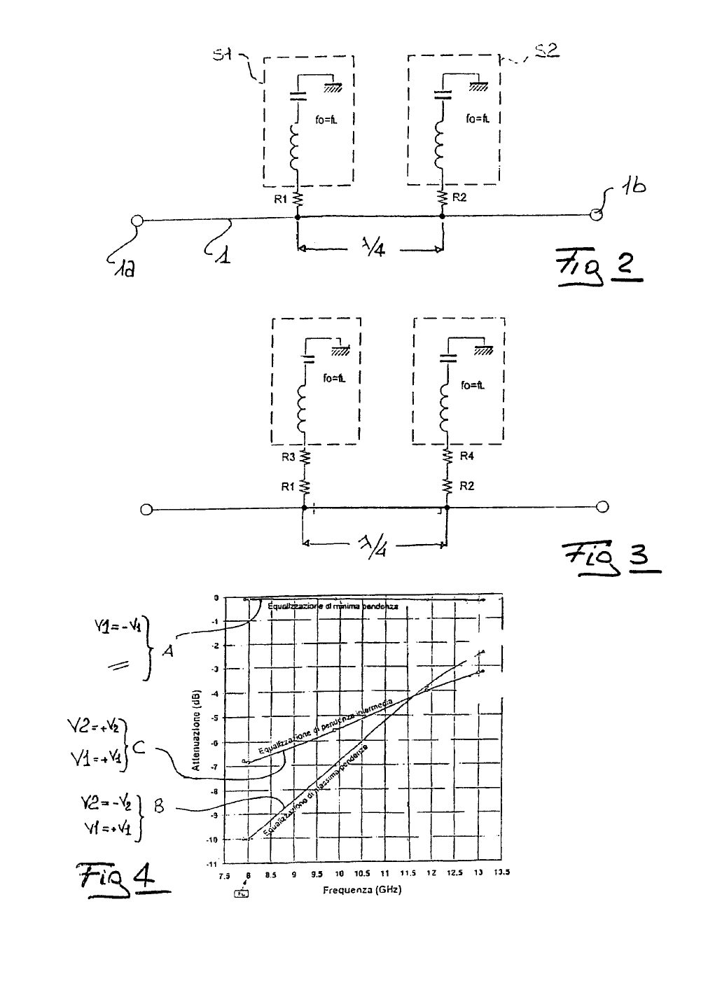

FIG. 3 shows the diagram of the equivalent circuit of the equalizer according to FIG. 1 corresponding to a second control condition;

FIG. 4 shows the graph for the transfer curves of the equalizer according to FIG. 1;

FIG. 5 shows the circuit diagram of a second embodiment of a variable equalizer according to the present invention;

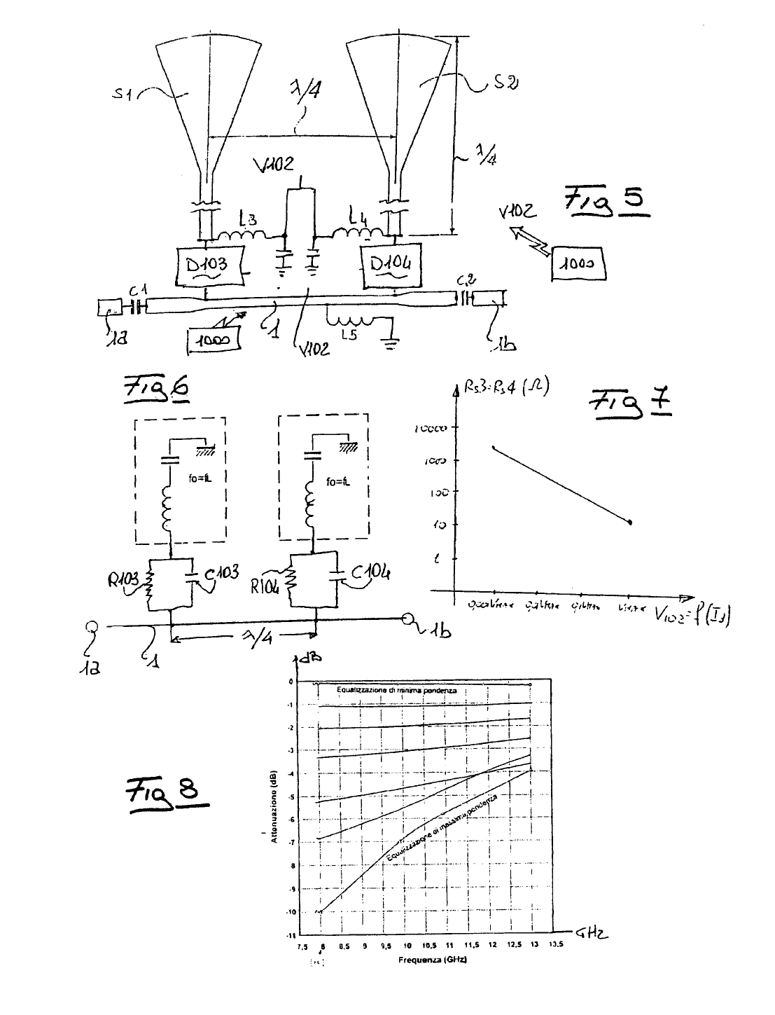

FIG. 6 shows the diagram of the equivalent circuit of the equalizer according to FIG. 5;

FIG. 7 shows the curve for the variable resistance values of the circuit for regulating the equalizer according to FIG. 5; and

FIG. 8 shows the graph for the transfer curves of the equalizer according to FIG. 5.

FIG. 1 shows a first example of an equalizer with a variable transfer curve (referred to below in short as variable equalizer) according to the present invention, which comprises:
a transmission line 1 having an input 1a and output 1b for the radio signal, there being provided between the input 1a and the line 1 and between the line 1 and the output 1b a respective capacitor C1,C2 able to allow the passage of the high-frequency signal and to interrupt the dc voltage applied to the aforementioned line.
Said transmission line 1 is connected to a calibration device which comprises:
   an earth connection formed by an inductor L5 in series with a capacitor C5 for respectively decoupling the frequency signal from the control circuit and for filtering the control voltage from frequency disturbance components;
   a first open circuit or open line section or stub S1 and a second open circuit or open line section or stub S2, each having a length corresponding to λ/4 and being spaced from each other by an amount equal to said length λ/4, where λ is the wavelength of the carrier at the lowest frequency of the nominal operating band of the equalizer.
the connection between the open stub S1 and the transmission line 1 is obtained by means of:
   a diode D1 arranged in series with a resistor R1 which is in turn arranged in series with a circuit branch 3 comprising a diode D3 in parallel with a resistor R3. The section between the resistor R1 and the branch 3 is connected to earth by means of a signal decoupling inductor L1.
The connection between the open stub S2 and the transmission line 1 is obtained by means of:
   a diode D2 arranged in series with a resistor R2 which is in turn arranged in series with a circuit branch 4 comprising a diode D4 in parallel with a resistor R4.

The section between the resistor R2 and the branch 4 is connected to earth by means of a signal decoupling inductor L2.

A first voltage V1 for controlling the equalization curve is applied between the impedance L5 and the capacitor C5. The voltage V1 may vary between two discrete values +V₁ and −V₁ and is generated by a control voltage generation device 1000.

A second control voltage V2 is applied between the inductor L3 and the capacitor C3 of the first open stub S1 and between the inductor L4 and the capacitor C4 of the second open stub S2.

Also this voltage, generated by the control device 1000, may assume discrete values +V₂ and −V₂ and allows variable calibration at discrete values of the equalization curve, as will become clearer below; the voltage V2 is filtered by the capacitors C3,C4 and supplied to the respective open stub S1,S2 via the inductor L3,L4 which decouples the supply signal;
a control device 1000 for regulating the control voltages V1 and V2; said control device 1000 may be of the manual type or such as to generate the said control voltages automatically in association with a programmable logic apparatus.

Said device 1000 also has an input for a supply voltage and a further input via which it is possible to introduce and store the values of the voltages V1 and V2 corresponding to the correct calibration values.

With reference to FIGS. 2, 3 and 4, operation of the variable equalizer according to FIG. 1 is as follows:
when the first regulating voltage V1 is supplied with a negative value −V₁, the two diodes D1 and D2 are inversely polarized and open, causing separation of the stubs S1 and S2, independently of the values of the second regulating voltage V2; in these conditions the equalizer is not influenced by the calibration circuit and the corresponding transfer curve A (FIG. 4) is substantially flat and does not produce any compensation;
when the first regulating voltage V1 is supplied with a positive value +V₁, the two diodes D1 and D2 are polarized directly and start to conduct, connecting the two open circuits S1,S2 to the transmission line 1 so as to allow calibration of the equalizer, in particular:
   when the second regulating voltage V2 is supplied with a negative value −V₂, the two diodes D3 and D4 are polarized directly and start to conduct, short-circuiting the corresponding resistors R3 and R4; the regulating circuit therefore keeps the only the resistors R1 and R2 active, producing compensation as per the curve B shown in FIG. 4;
   when the second regulating voltage V2 is supplied with a positive value +V₂, the two diodes D3 and D4 are inversely polarized and are inhibited, resulting in conduction of the respective resistors R3 and R4; the regulating circuit therefore keeps active both pairs of series resistors R1+R3 and R2+R4, producing compensation as per the curve C shown in FIG. 4.

Since the gradient of the compensation curves depends on the value of the active resistors, it can be understood how the curve B which is determined by the sole resistors R1 and R2 has a gradient which is greater than that of the curve C which depends on the sum if the resistors R1+R3 and R2+R4, resulting in a transfer function, between the input and output ports, with an attenuation which is inversely proportional to the frequency.

Considering that at the minimum frequency value FL of the predetermined working frequency the open stub is equivalent to a short-circuit at the junction between L3 and R3 and between L4 and R4, it is possible to schematically represent the equalizer as a two-port network with the two earthed resistors R1/R1+R3 and R2/R2+R4 at a distance of λ/4 from each other. In order to achieve the necessary adaptation, the values of the resistors must be calculated taking into account the said distance, equal to λ/4, between the two resistors and so that the impedance of the circuit at the input and output does not deviate significantly from the characteristic impedance of the transmission line (typically 50 ohms).

FIG. 5 shows a second example of embodiment of the equalizer according to the invention which comprises the same transmission line 1 and the same open circuits S1 and S2 as in the example of FIG. 1, in respect of which the same reference numbers are used for the various component parts; the connection between the two open stubs S1 and S2 and the line 1 is in this case achieved by means of the connection of respective P.I.N. diodes D103 and D104 which are polarized by the control voltage V102.

These diodes are designed with a wide region of Intrinsic non-doped semiconductor material contained between a type P doped semiconductor and a type N doped semiconductor (hence the abbreviation P.I.N.) and have the characteristic feature of possessing a resistance which is variable depending on the polarization current which is applied to them.

The diodes D103 and D104 may therefore be represented by means of equivalent electric circuits (FIG. 6) respectively comprising a resistor R103,R104 in parallel with a capacitor C103, C104 which determine an equivalent resistor Rs3,Rs4, the value of which is inversely proportional to the direct polarization current of the diodes D103 and D104. which is in turn regulated by the control voltage V102 generated by the control circuit 1000.

By regulating the control voltage V102 on the diodes D103,104, a continuous variation (FIG. 7) of the equivalent resistances Rs4,Rs4 is therefore obtained, this in turn producing a variation of the equalizer transfer curves as shown in FIG. 8, which shows curves for an equalizer having dimensions for a band width greater than FL/2 and a variation in the resistance Rs3,Rs4 of the diodes D103,D104 in the range of 50-3000 ohms.

Said control voltage V102 varies within a range of values such that adaptation of the line is maintained.

With this embodiment it is possible to obtain a continuous variation of the equivalent resistance for each given frequency range, resulting in a corresponding continuous variation of the gradient of the equalizer transfer function; this in turn ensures greater precision in linearization of the entire receiver unit even if, compared to the discrete-value structure, the linearity of the transfer curve of the receiver is reduced upon variation in the frequency for high input power levels.

It is therefore clear how with a variable equalizer according to the invention it is possible to modify its transfer curve by means of adjustment of electric parameters with a consequent reduction in the calibration and testing time, reduction in the frequency of human errors and increased independence of the calibration quality with respect to the capacity of the individual operator, as well as an overall increase in the repeatability of the operating characteristics of the equalizers with a consequent percentage reduction of the production rejects.

Although described in connection with few non-limiting embodiments and few preferred non-limiting constructional examples of the invention, it is understood that the scope of protection of the present patent is defined solely by the following claims.

1. Microwave signal equalizer comprising a signal transmission line (1), a first open stub (S1) and a second open stub (S2) which are applied in parallel to the said transmission line (1) by means of a respective connection circuit (D103,D104;D1,R1,3,D2,R2,4), characterized in that said first open stub (S1) and second open stub (S2) are controlled by at least one second dc control voltage (V2;V102) which is applied to the respective connection circuit (D103,D104; D1,R1,3,D2,R2,4,D3,R3,D4,R4),
in that said second control voltage (V2;V102) is variable and
in that said connection circuit (D103,D104;D1,R1,3,D2,R2,4,D3, R3,D4,R4) is able to produce a variable resistance upon variation of said second control voltage (V2;V102).

2. Equalizer according to claim 1, characterized in that said first open stub (S1) and second open stub (S2) have a length corresponding to λ/4.

3. Equalizer according to claim 1, characterized in that said first open stub (S1) and second open stub (S2) are spaced from each other by an amount equal to λ/4.

4. Equalizer according to claim 1, characterized in that the circuit (D103,D104;D1,R1,3,D2,R2,4,D3,R3,D4,R4) for connecting each open stub (S1,S2) and the transmission line (1) comprises a respective PIN diode (D103,D104) which is polarized by said second control voltage (V102).

5. Equalizer according to claim 1, characterized in that said control voltage (V102) varies continuously.

6. Equalizer according to claim 5, characterized in that said control voltage (V102) varies within a range of values such that adaptation of the line is maintained.

7. Equalizer according to claim 11, characterized in that said transmission line (1) has en earthed connection branch comprising an inductor (L5) in series with a capacitor (C5).

8. Equalizer according to claim 7, characterized in that a first control voltage (V1) is applied to the said earthed connection branch.

9. Equalizer according to claim 8, characterized in that said first control voltage (V1) is applied between the impedance (L5) and the capacitor (C5) of the earthed connection branch of the transmission line (1).

10. Equalizer according to claim 8, characterized in that said first control voltage (V1) and second control voltage (V2) vary with discrete values.

11. Equalizer according to claim 10, characterized in that the connection between the first open stub (S1) and the transmission line (1) is obtained by means of a diode (D1) arranged in series with a resistor (R1) in turn arranged in series with a circuit branch (3) comprising a diode (D3) in parallel with a resistor (R3).

12. Equalizer according to claim 11, characterized in that the section between the resistor (R1) connecting the first open stub (S1) and the respective circuit branch (3) is connected to earth via a signal decoupling inductor (L1).

13. Equalizer according to claim 10, characterized in that the connection between the second open stub (S2) and the transmission line (1) is obtained by means of a diode (D2) arranged in series with a resistor (R2) in turn arranged in series with a circuit branch (4) comprising a diode (D4) in parallel with a resistor (R4).

14. Equalizer according to claim 13, characterized in that the section between the resistor (R2) connecting the second open stub (S2) and the transmission line (1) and the respective circuit branch (4) is connected to earth via a signal decoupling inductor (L2).

15. Equalizer according to claim 11 or 13, characterized in that the second control voltage (V2) is applied between the inductor (L3) and the capacitor (C3) of the first open stub (S1) and between the inductor (L4) and the capacitor (C4) of the second open stub (S2).

16. Equalizer according to claim 10, characterized in that the first control voltage (V1) is supplied with a negative value (−V₁) for inverse polarization of the two diodes (D1,D2) connecting the respective open circuits (S1,S2) to the transmission line (1).

17. Equalizer according to claim 10, characterized in that the first regulating voltage (V1) is supplied with a positive value (+V₁) for direct polarization of the two diodes (D1,D2) connecting the respective open circuits (S1,S2) to the transmission line (1).

18. Equalizer according to claim 17, characterized in that the second control voltage (V2) is supplied with a negative value (−V₂) for direct polarization of the diode (D3,D4) of the respective circuit branch (3,4).

19. Equalizer according to claim 17, characterized in that the second control voltage (V2) is supplied with a positive value (+V₂) for inverse polarization of the diode (D3,D4) of the respective circuit branch (3,4).

20. Equalizer according to claim 1, characterized in that it comprises a control device (1000) supplied by a respective supply voltage and able to regulate the said first and second control voltages (V1;V2;V102).

21. Equalize'r according to claim 20, characterized in that it comprises an input for introduction and storage of the correct values of the said control voltages (V1,V2;V102).

22. Equalizer according to claim 20, characterized in that said control device (1000) is manual.

23. Equalizer according to claim 20, characterized in that said control voltage (1000) is associated with a programmable logic apparatus for automatically generating the control voltages (V1,V2;V102).
